(19) United States
(12) Patent Application Publication
(10) Pub. No.: US 2023/0375498 A1
(43) Pub. Date: Nov. 23, 2023

(54) STORAGE METHOD OF CHEMICAL SENSOR AND SEALING STRUCTURE OF CHEMICAL SENSOR

(71) Applicant: KABUSHIKI KAISHA TOSHIBA, Tokyo (JP)

(72) Inventors: Miyu NAGAI, Yokohama Kanagawa (JP); Yoshiaki SUGIZAKI, Fujisawa Kanagawa (JP); Hideyuki TOMIZAWA, Ota Gumma (JP)

(73) Assignee: KABUSHIKI KAISHA TOSHIBA, Tokyo (JP)

(21) Appl. No.: 18/183,545

(22) Filed: Mar. 14, 2023

(30) Foreign Application Priority Data
May 19, 2022 (JP) 2022-082354

(51) Int. Cl. G01N 27/414; B01L 3/00

(52) U.S. Cl. CPC G01N 27/414; B01L 3/502761; B01L 2300/0645; B01L 2200/0689; B01L 2200/0652

(57) ABSTRACT

According to one embodiment, the storing method includes (S1) preparing the chemical sensor in which a probe molecule for capturing the target substance is immobilized on at least a part of a surface of the sensitive film, and (S2) forming a protective film that is formed of a water-soluble material on the surface so as to cover the surface on which the probe molecule is immobilized.

### CROSS-REFERENCE TO RELATED APPLICATIONS

This application is based upon and claims the benefit of priority from Japanese Patent Application No. 2022-082354, filed May 19, 2022, the entire contents of which are incorporated herein by reference.

### FIELD

Embodiments described herein relate generally to a storage method of a chemical sensor and a sealing structure of the chemical sensor.

### BACKGROUND

It is required to establish a storage method and a sealing structure of a chemical sensor that enable stable long-term storage of the chemical sensor that includes a sensitive film on which probe molecules are modified.

### BRIEF DESCRIPTION OF THE DRAWINGS

FIG. 1 is a schematic view illustrating an example of a sealing structure of a chemical sensor according to a first embodiment, in which part (a) of FIG. 1 illustrates a sealing structure applied to a chemical sensor, and part (b) of FIG. 1 illustrates a sealing structure applied when the chemical sensor illustrated in part (a) of FIG. 1 further includes an insulator that covers electrodes.

FIG. 2 is a schematic view illustrating an example of a chemical sensor of a second embodiment.

FIG. 3 is a flowchart illustrating a method for storing a chemical sensor that includes a sensitive film for detecting a target substance according to a third embodiment.

FIG. 4 is a flowchart illustrating a method according to a fourth embodiment, that is, a method of using the chemical sensor that includes the sealing structure according to the first embodiment or the second embodiment.

FIG. 5 is a view illustrating a method of using the chemical sensor that includes the sealing structure according to the second embodiment among the methods according to the fourth embodiment.

FIG. 6 is a schematic view illustrating a sealing structure of a chemical sensor according to a fifth embodiment, in which part (a) of FIG. 6 illustrates a sealing structure in which a surface on which a removal solution is dropped has an arch shape, and part (b) and (c) of FIG. 6 illustrate a sealing structure in which a surface on which a removal solution is dropped forms a liquid storage structure.

FIG. 7 is a schematic view illustrating a sealing structure of a chemical sensor according to a sixth embodiment.

Part (a) of FIG. 8 is a schematic view illustrating a chemical sensor that includes a plurality of sensor elements before forming a sealing structure, and part (b) of FIG. 8 is an enlarged view of a surrounding portion A in part (a) of FIG. 8.

FIG. 9 is a schematic view illustrating a sealing structure according to a seventh embodiment, that is, a sealing structure of each sensor element of a chemical sensor that includes a plurality of sensor elements.

FIG. 10 is a schematic view illustrating the sealing structure of the chemical sensor that includes the plurality of sensor elements according to the seventh embodiment, in which part (a) of FIG. 10 illustrates a configuration including one protective film for each sensor element, and part (b) and (c) of FIG. 10 illustrate a configuration in which each sensor element shares one protective film.

FIG. 11 is a schematic view illustrating the sealing structure of the chemical sensor according to the seventh embodiment, in which part (a) of FIG. 11 illustrates a chemical sensor that includes a bank portion for forming a sealing structure, and part (b) of FIG. 11 illustrates a configuration in which a sealing structure is formed in the chemical sensor and is a cross-sectional view taken along line ii-ii in part (a) of FIG. 11 (a wavy line indicates that the structure sandwiched between the lines is repeated).

FIG. 12 is a schematic view illustrating a sealing structure of a chemical sensor according to an eighth embodiment.

FIG. 13 is a schematic view illustrating a configuration of the chemical sensor that includes the sealing structure according to the eighth embodiment.

### DETAILED DESCRIPTION

In general, according to one embodiment, the storing method includes (S1) preparing the chemical sensor in which a probe molecule for capturing the target substance is immobilized on at least a part of a surface of the sensitive film; and (S2) forming a protective film that is formed of a water-soluble material on the surface so as to cover the surface on which the probe molecule is immobilized.

Embodiments will be described hereinafter with reference to the accompanying drawings. Note that throughout the embodiments, substantially identical structural parts are denoted by the same reference symbols, respectively, and the descriptions therefor may be partially omitted. Further, the drawings are schematically illustrated, and therefore the relationship between the thickness of each part and the planer dimension thereof, and the ratios between the thicknesses among the respective parts, and the like may be different from those of actual modes.

### First Embodiment

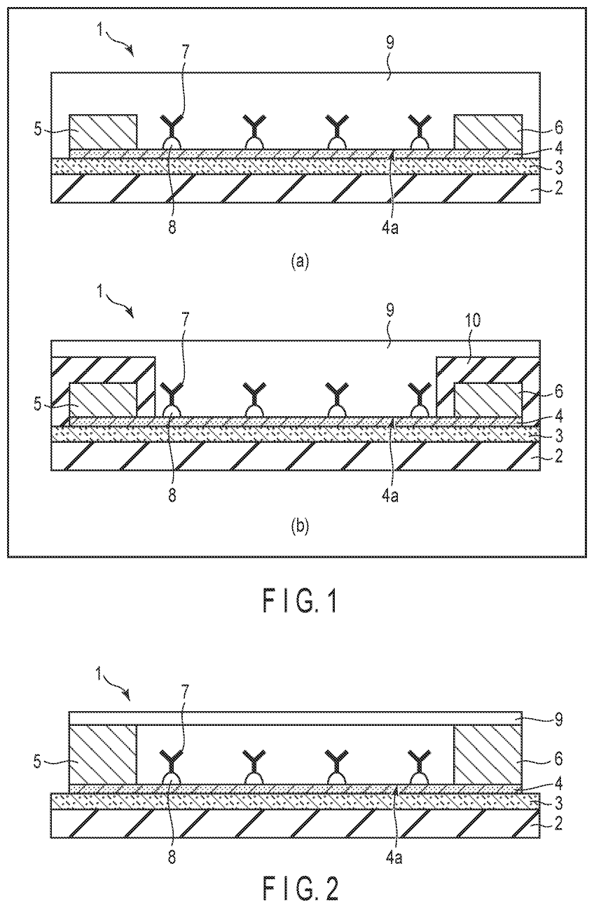

In a first embodiment, as a sealing structure for storing a chemical sensor, a sealing structure of a gas sensor for detecting a target substance in the atmosphere will be described as an example. Note that, for the chemical sensor, the target substance contained in a solution in contact with a sensitive film may be used as a detection target. In addition, as a gas sensor to be used for measurement of a target substance, a gas sensor that includes a sensor element 1 having a configuration of an FET as illustrated in part (a) of FIG. 1 will be described as an example.

The sensor element 1 includes a substrate 2 formed of a semiconductor material, an insulating layer 3 provided on the substrate 2, and a sensitive film 4 provided on the insulating layer 3. The substrate 2 is a substrate for placing the sensitive film 4 on a surface thereof, and is formed of, for example, a semiconductor material such as silicon, germanium, gallium nitride, or gallium carbide, various conductive materials, or an insulating material. The insulating layer 3 has an insulating property, and is formed of, for example, silicon dioxide or a rubber insulating material. In addition, as electrical connection of the sensor element 1, one electrode 5 is connected to one end portion of the sensitive film 4, and the other electrode 6 is connected to the other end portion of the sensitive film 4.

A part of a surface of the sensitive film 4 of the sensor element 1 is configured to be exposed to an external environment when used for measurement as a sensor. That is, in the gas sensor illustrated in part (a) of FIG. 1, the surface of the sensitive film 4 (hereinafter, also referred to as a sensitive film surface 4a) can be exposed to the external environment from an opening formed by using one electrode 5 and the other electrode 6 as side walls. Here, the “external environment” is, for example, the atmosphere containing a target substance.

The sensitive film 4 senses a physicochemical change generated when probe molecules 7 capture the target substance as a change in electrical characteristics. The sensitive film 4 may be formed of, for example, a carbon allotrope such as single layer graphene, laminated graphene, graphite, or carbon nanotube, or a metal oxide such as tin dioxide.

The probe molecules 7 for capturing the target substance when used for measurement as a sensor are immobilized on the sensitive film surface 4a. The probe molecule 7 is a substance having binding and adsorption abilities specific to the target substance. The probe molecule 7 is, for example, a protein such as an enzyme or an antibody, a nucleic acid aptamer, a peptide aptamer, or a derivative containing a motif thereof. The probe molecule 7 may be a substance covalently bound to the sensitive film 4 or may include a linker moiety 8 having an adsorption ability to the sensitive film 4. In a case where the sensitive film 4 is formed of a carbon allotrope, the probe molecule 7 contains, for example, a polycyclic aromatic system as the linker moiety 8.

The electrodes 5 and 6 output a change in electrical characteristics of the sensitive film 4 to the outside of the sensor element 1 as an electrical signal. For example, a predetermined voltage is applied between the electrodes 5 and 6 during an operation of the sensor element 1 and the change in electrical characteristic of the sensitive film 4 can be detected based on the change between the electrodes 5 and 6.

The sensitive film 4 and the electrodes 5 and 6 function as field-effect transistors (FETs). In this case, the electrodes 5 and 6 are source electrodes or drain electrodes. The sensor element 1 may include a gate electrode (not illustrated) that applies an electric field to the sensitive film 4. The gate electrode can be provided so as to face the sensitive film 4 with the insulating layer 3 interposed therebetween, or can be provided so as to be in contact with an inspection solution supplied to the sensitive film 4 at the time of sensing.

The gas sensor that includes the sensor element 1 described above includes the protective film 9 that covers the sensitive film surface 4a as an unused form such as a storage form. That is, the protective film 9 is a sealing structure of the gas sensor, and is configured to separate the sensitive film 4a and the probe molecules 7 from the external environment to prevent the sensitive film and the probe molecules 7 from coming into contact with external environment.

The protective film 9 is formed of a water-soluble material. As the water-soluble material, for example, a water-soluble resin such as a water-soluble plastic can be selected. The water-soluble material is preferably a material that improves the storage state, and such a material has no charge, has no influence on a pH concentration of a buffer solution, and has a physical property or amount that does not inhibit structural retention of the probe molecule. Examples of the water-soluble material having these three characteristics include polyvinyl alcohol. Furthermore, the water-soluble material may also contain any reagents (for example, a stabilizer, a pH adjusting agent, and the like) required for measurement or storage of the sensor element 1. Here, the expression of “having a charge” means that a material that is strongly ionized, strongly charged, or has strong polarity forms an electric double layer having a capacity sufficient to reduce the reactivity of the sensitive film. The expression of “affecting the pH concentration of the buffer solution” means that an acid or basic material changes the pH concentration within a range in which the buffer solution does not exhibit pH buffering properties. The expression of the “inhibits the structural retention of the probe molecule” means that a certain material inhibits, for example, normal intramolecular binding of a probe molecule or is adsorbed to a probe molecule to distort a three-dimensional structure.

As described above, the sealing structure of the chemical sensor according to the first embodiment, that is, the protective film that covers the sensitive film surface is provided, such that even when the environment for storing the chemical sensor is a contaminated environment in which impurities are observed, the sensitive film surface is sealed by the protective film, and thus the chemical sensor can be stably stored for a long period of time.

In addition, as will be described below, since the protective film as the sealing structure of the chemical sensor according to the first embodiment is formed of a water-soluble material, it is possible to easily remove the protective film by dropping any aqueous solution on the protective film. Furthermore, as the chemical sensor including the probe molecules which are easily denatured or damaged when brought into contact with an organic solvent, it is more preferable that the solution used for removing the protective film is an aqueous solution.

As a further embodiment, the sensor element 1 may include an insulator 10 that covers one electrode 5 and the other electrode 6 and a part of the surface of the sensitive film 4 as illustrated in part (b) of FIG. 1. In this case, the sensitive film surface 4a that can be exposed to the external environment when used as a sensor is a surface of the sensitive film exposed from an opening formed by the insulator 10 as a side wall. The insulator 10 may be formed as an integral member. As the integral insulator 10, for example, an insulator 10 that covers one electrode 5 and an insulator 10 that covers the other electrode 6 may be coupled by an insulator (not illustrated) extending in a cross-sectional direction of part (b) of FIG. 1 to form a frame shape exposing the sensitive film surface 4a. In other words, the insulator 10 is a member whose main surface is a surface facing a main surface of the substrate 2, and has a hole penetrating in a direction intersecting with the main surface. The hole of the insulator 10 forms a recessed structure whose one side is blocked by the sensitive film surface 4a, that is, an opening.

The insulator 10 is formed of, for example, silicon dioxide or a rubber insulating material. When used as a sensor, there is a case where a liquid film is formed by dropping a measurement solution on the sensitive film 4. One electrode 5 and the other electrode 6 are covered with the insulator 10, such that it is possible to prevent a short circuit and an electric leakage, and the sensitive film 4 can function as an FET.

### Second Embodiment

A sealing structure for storing a chemical sensor according to a second embodiment will be described with reference to FIG. 2. Here, the same members as those of the first embodiment are denoted by the same reference numerals, and the description thereof will be omitted.

As illustrated in FIG. 2, the sealing structure of the chemical sensor according to the second embodiment is different from the sealing structure of the chemical sensor according to the first embodiment in that a protective film 9 is in a form of a film stretched between one electrode 5 and the other electrode 6, and the protective film 9 does not come into contact with a sensitive film 4.

In the second embodiment, an opening formed by using one electrode 5 and the other electrode 6 as side walls is sealed by the protective film 9, such that a sensitive film surface 4a is separated from an external environment. A space filled with a gas (for example, a gas containing a material suitable for storage may be used) is formed between the film-shaped protective film 9 and the sensitive film 4 and between the electrodes 5 and 6. Note that as long as the protective film 9 covers the sensitive film surface 4a with the space therebetween, the protective film 9 may have a configuration in which a specific material (for example, a gas containing a material suitable for storage) can pass through the protective film 9 (that is, a specific material can be replaced between the space and the atmosphere), or may have a configuration in which the space is isolated from the atmosphere.

Similar to the first embodiment, the sealing structure according to the second embodiment can stably store the chemical sensor for a long period of time even when an environment for storing the chemical sensor is a contaminated environment in which impurities are observed.

As a further embodiment, a sensor element 1 may include an insulator that covers one electrode 5 and the other electrode 6 and a part of the surface of the sensitive film 4. As a further embodiment, the sensitive film surface that can be exposed to an external environment when used as a sensor is a surface of the sensitive film exposed from an opening including the insulator as a side wall. In a further embodiment, the protective film is disposed so as to be stretched between an insulator that covers one electrode and an insulator that covers the other electrode.

### Third Embodiment

A third embodiment provides a method for storing a chemical sensor that includes a sensitive film for detecting a target substance. Note that the method according to the third embodiment can also be provided as a method for manufacturing a chemical sensor that includes the sealing structure according to the first embodiment or the second embodiment.

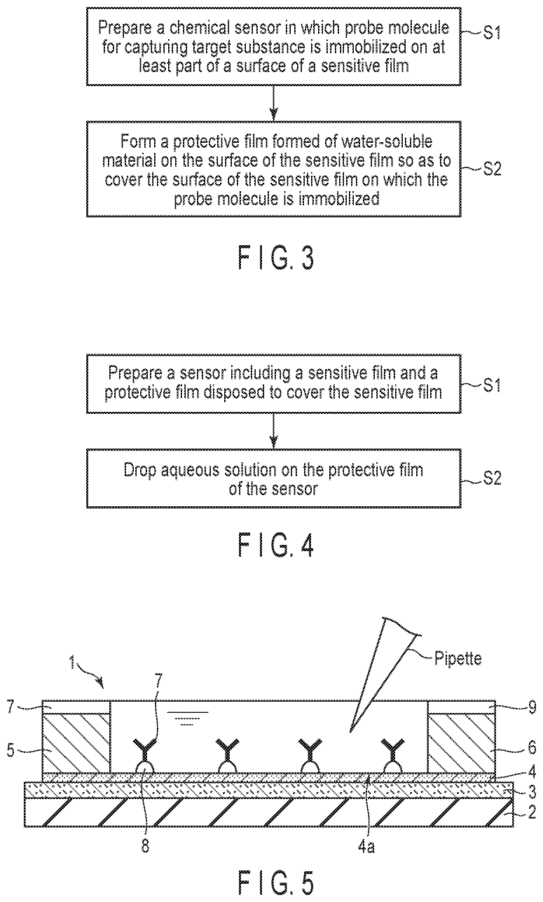

As illustrated in FIG. 3, the method according to the third embodiment includes: (S1) preparing a chemical sensor in which probe molecules for capturing a target substance are immobilized on at least a part of a surface of a sensitive film; and (S2) forming a protective film that is formed of a water-soluble material on the surface of sensitive film so as to cover the surface of the sensitive film on which the probe molecules are immobilized.

The sealing structure of the chemical sensor described in the first embodiment is formed by covering a surface of the sensor element including the surface of the sensitive film with the protective film. The protective film may be formed by a desired method. For example, the protective film may be formed on the sensitive film surface by applying the protective film material containing the water-soluble material described in the first embodiment onto the sensitive film surface and curing the protective film material.

In addition, as a further embodiment, the method according to the third embodiment is a method for storing a chemical sensor that includes a sensitive film for detecting a target substance, the method including: (S1) preparing a chemical sensor that includes a substrate, a side wall erected from the substrate and forming an opening on the substrate, and a sensitive film having a surface on which probe molecules are immobilized, the surface being exposed to an external environment from the opening; and (S2) forming a protective film that is formed of a water-soluble material so as to seal the opening.

The sealing structure of the chemical sensor described in the second embodiment is formed so as to seal the opening exposing a part of the surface of the sensitive film to the external environment. Since the opening is constituted by the side wall erected from the substrate, the protective film can be formed by bonding a film formed of a protective film material so as to be stretched over the side wall.

In the method in which the protective film material is applied to the sensitive film surface and cured to form the protective film, the amount of the protective film material applied tends to be relatively large in order to reliably cover the sensitive film surface with the protective film. However, since the sealing structure of the chemical sensor according to the second embodiment is formed using an already cured film, the amount of the protective film material used can be reduced.

### Fourth Embodiment

A fourth embodiment provides a method of using a chemical sensor that includes the sealing structure according to the first embodiment or the second embodiment.

As illustrated in FIG. 4, the method according to the fourth embodiment includes: (S1) preparing a chemical sensor that includes a sensitive film and a protective film disposed so as to cover the sensitive film, and an aqueous solution for removing the protective film; and (S2) dropping the aqueous solution prepared in (S1) on the protective film of the sensor prepared in (S1).

As described in the first embodiment and the second embodiment, the sensor prepared in Step S1 is a chemical sensor that includes a protective film as a sealing structure, and it is required to remove the protective film in order to use the chemical sensor as a sensor.

The aqueous solution prepared in Step S1 is an aqueous solution capable of dissolving a protective film material (hereinafter, referred to as a “removal solution”). A solubility of the protective film material in the removal solution is preferably higher from the viewpoint of removal efficiency of the protective film. In addition, the removal solution may contain any solute as long as the member constituting the sensor is not damaged. That is, the removal solution may be used for a purpose other than dissolving the protective film of the sensor, for example, a purpose of a measurement solution at the time of using the sensor.

As described in the first embodiment and the second embodiment, since the protective film is formed of a water-soluble material, the protective film is dissolved by the aqueous solution in Step S2.

After Step S2, instead of the protective film, a liquid film formed of the removal solution in which the protective film material is dissolved is formed on the sensitive film. Whether or not to remove the liquid film is determined according to the measurement conditions of the sensor, the type of the target substance, the constituent members of the sensor, and the like. For example, in a case where the protective film material inhibits measurement using the sensor, it is preferable to remove the liquid film. In a case where the protective film material does not affect the measurement, the liquid film may be used as a measurement solution, and the target substance can be measured by the sensor immediately after Step S2. The liquid film can be removed by any method, and may be removed by, for example, a pump or the like, or may be removed by using a pipette or the like.

According to the method according to the fourth embodiment, the protective film can be removed by dropping the removal solution on the protective film. Therefore, an operation at the time of using the sensor is easy, which is preferable. In addition, according to the method according to the fourth embodiment, for example, since a physical operation such as peeling of the protective film is not exerted on the sensor, it is also preferable that the possibility of damaging the sensor can be reduced.

Further, as described in the first embodiment, a probe formed of peptide or DNA is bound to a surface of the sensitive film. In general, such a probe may be denatured or damaged by being brought into contact with an organic solvent. However, according to the method according to the fourth embodiment, an organic solvent may not be used for removing the protective film, which is preferable.

As a further embodiment, another method for using a chemical sensor that includes the sealing structure according to the second embodiment is provided. For example, the removal solution may not be dropped on the protective film 9. For example, as illustrated in FIG. 5, a through-hole may be formed in the protective film 9 using a pipette, and the removal solution may be dropped from the through-hole on a sensitive film surface 4a. In the chemical sensor that includes the sealing structure according to the second embodiment, a space is provided between the film-shaped protective film 9 and the sensitive film surface 4a (see FIG. 2), the removal solution is dropped so as to fill the space, and the protective film 9 is dissolved and removed by contact with a liquid surface of the removal solution.

### Fifth Embodiment

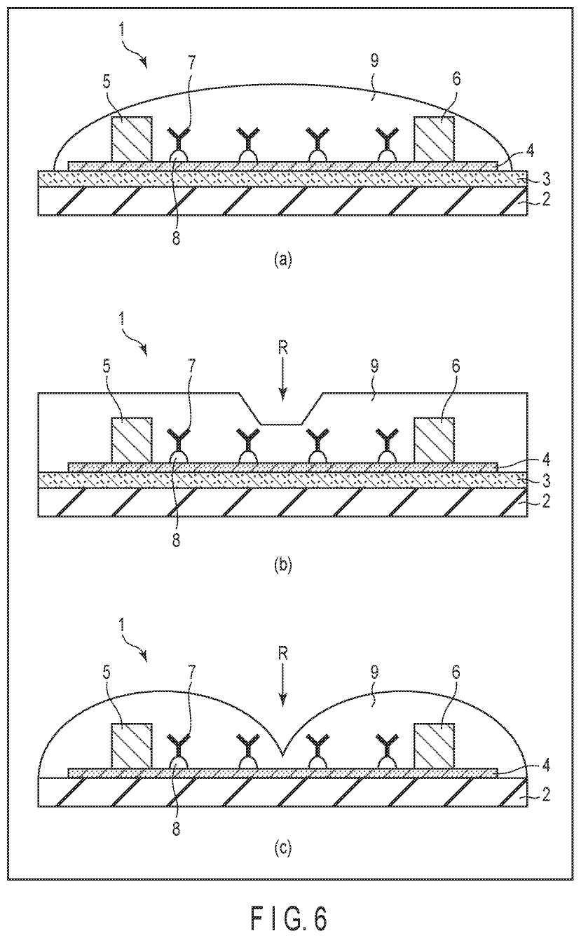

A sealing structure for storing a chemical sensor according to a fifth embodiment will be described with reference to FIG. 6. Here, the same members as those of the first embodiment are denoted by the same reference numerals, and the description thereof will be omitted.

The sealing structure according to the fifth embodiment is different from that of the first embodiment in that a protective film that is a sealing structure has an arch shape or forms a liquid storage structure.

As illustrated in part (a) of FIG. 6, a surface 8a of a protective film 9 on which a removal solution is dropped has an arch shape. When the surface 8a has an arch shape, the removal solution is easily dispersed on the surface 8a by the action of gravity. In addition, since a contact area between the protective film 9 and the removal solution is increased as compared with a case where the surface 8a is flat, dissolution of the protective film 9 can be promoted.

In addition, the surface 8a may form a liquid storage structure R. For example, as illustrated in part (b) of FIG. 6, a concave portion may be provided on the surface 8a as the liquid storage structure R. That is, the protective film 9 may be provided with a cutout portion serving as the liquid storage structure R. Alternatively, as illustrated in part (c) of FIG. 6, a protective film 9 having a shape in which a plurality of arches are partially brought into contact with each other is prepared, such that a space sandwiched by the arches may be used as the liquid storage structure R. In a case where the liquid storage structure R is formed on the surface 8a, a larger amount of the removal solution can be added to bring the surface 8a into contact with the protective film 9, and the dissolution of the protective film 9 can be promoted.

### Sixth Embodiment

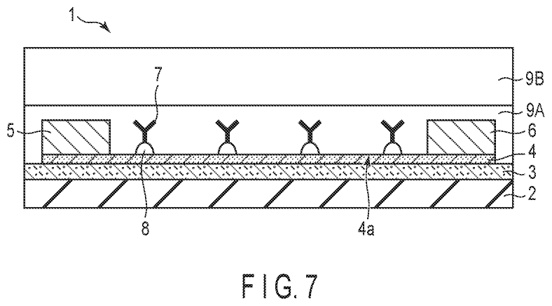

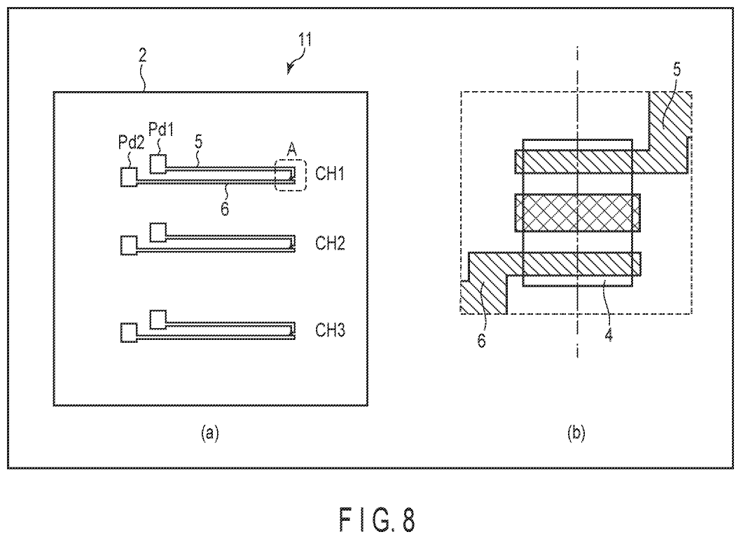

A sealing structure for storing a chemical sensor according to a sixth embodiment will be described with reference to FIG. 7. Here, the same members as those of the first embodiment are denoted by the same reference numerals, and the description thereof will be omitted.

The sealing structure according to the sixth embodiment is different from the sealing structure of the first embodiment in that a protective film 9 is formed so that a plurality of layers formed of different types of materials overlap each other. As illustrated in FIG. 7, the protective film 9 includes two layers of a lower layer 9A that covers a sensitive film 4 and an upper layer 9B that covers the lower layer 9A and being in contact with an external environment, and the upper layer 9B and the lower layer 9A are formed of water-soluble materials having compositions different from each other.

Since the water-soluble material constituting the upper layer 9B is exposed to the external environment, the water-soluble material is easily affected by humidity and impurities. Therefore, the water-soluble material constituting the upper layer 9B preferably has relatively low water solubility and reactivity. Examples of the water-soluble material having relatively low water solubility and reactivity include a resol-type phenolic resin or a completely saponified-type PVA.

On the other hand, the water-soluble material constituting the lower layer 9A preferably has high adhesion to a member (for example, a sensitive film 4, one electrode 5, the other electrode 6, an insulator 10, or the like) of a sensor element 1. In addition, since the lower layer 9A is covered with the upper layer 9B, the lower layer 9A is hardly affected by the humidity of the external environment. From the viewpoint of improving the removal efficiency of the protective film, the water solubility of the water-soluble material constituting the lower layer 9A is preferably higher. Here, the high water solubility can be rephrased as high solubility or a magnitude of a dissolution rate. Examples of a water-soluble resin having high adhesion and high water solubility include carboxymethyl cellulose (CMC) and partially saponified-type PVA.

In the sealing structure according to the sixth embodiment, the materials constituting the upper layer 9B and the lower layer 9A are adjusted, such that moisture resistance and a holding force of the protective film 9 can be adjusted.

Although the case where the protective film of the sensor according to the sixth embodiment has a two-layer laminated structure has been described above, the protective film may be formed so as to have a multilayer structure. For example, a film layer 9C that covers the upper layer 9B may be further provided for improving the moisture resistance and the holding force of the protective film. The film layer 9C may be laminated on the upper layer 9B with the upper layer 9B as an adhesive layer. The film layer 9C is formed of a material different from those of the lower layer 9A and the upper layer 9B, and the material preferably has higher moisture resistance and mechanical strength. The film layer 8C may be removed by peeling when the sensor is used.

### Seventh Embodiment

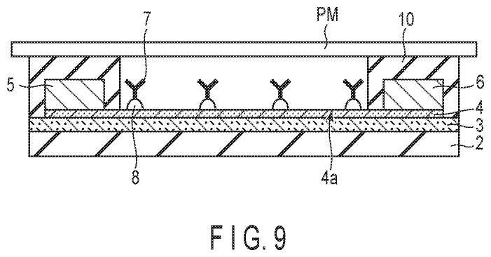

A sealing structure for storing a chemical sensor according to a seventh embodiment will be described with reference to FIGS. 8 and 9. Here, the same members as those of the first embodiment are denoted by the same reference numerals, and the description thereof will be omitted.

The seventh embodiment relates to a sealing structure for storing a chemical sensor that includes a combination of a plurality of sensor elements described in the first to sixth embodiments on the same substrate.

As illustrated in part (a) of FIG. 8, a chemical sensor 11 before a protective film as a sealing structure is formed includes a plurality of sensor elements CH1 to CH3 on the same substrate 2. Each sensor element includes one electrode 5 and the other electrode 6, a pad electrode Pd1 is connected to one electrode 5, and a pad electrode Pd2 is connected to the other electrode 6.

Part (b) of FIG. 8 illustrates an enlarged view of the vicinity of the sensor element CH1 (surrounding portion A) in part (a) of FIG. 8. As illustrated in part (b) of FIG. 8, one electrode 5 and the other electrode 6 of each sensor element are connected to a sensitive film 4 constituting each sensor element.

In the chemical sensor 11 illustrated in part (a) and (b) of FIG. 8, a protective film is formed so as to cover a surface of the sensitive film 4 of each sensor element by the same method as that of the third embodiment. FIG. 9 illustrates a cross-sectional view connecting line i-i in part (b) of FIG. 8 after the protective film is formed. As illustrated in FIG. 9, each sensor element is provided with a protective film PM so as to be stretched between an insulator that covers one electrode 5 and an insulator that covers the other electrode 6, thereby sealing a sensitive film surface 4a.

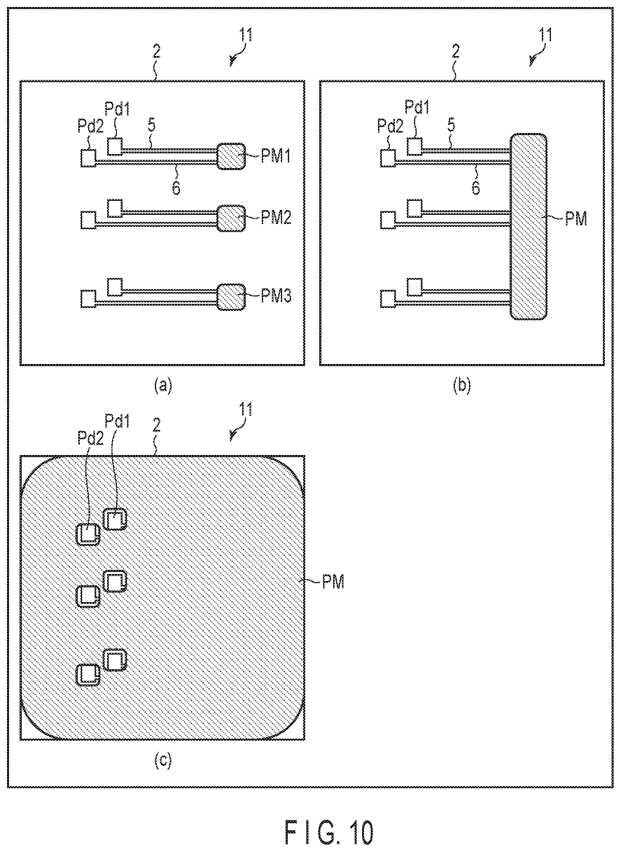

Here, each sensor element may include one protective film for each sensor element. For example, as illustrated in part (a) of FIG. 10, the sensor elements CH1 to CH3 may include protective films PM1 to PM3, respectively. In addition, as illustrated in part (b) and (c) of FIG. 10, each sensor element may share one protective film.

Part (b) of FIG. 10 illustrates a configuration in which a protective film shared by the sensor elements CH1 to CH3 is formed so as to cover a region of the surface of the chemical sensor 11 where each of the sensor elements CH1 to CH3 is in contact with a removal solution. As illustrated in part (c) of FIG. 10, the protective film shared by the sensor elements CH1 to CH3 may be configured to cover a region of the surface of the sensor 11 other than a portion where each pad electrode is exposed.

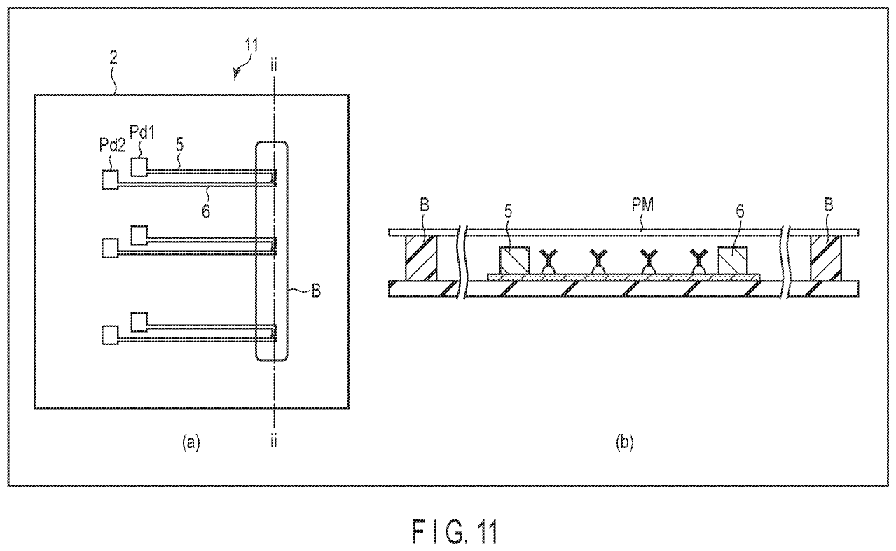

In FIG. 9 and part (a) to (c) of FIG. 10, a configuration in which the chemical sensor 11 includes an insulator 10 has been exemplified, but as a further embodiment, the chemical sensor 11 may not include the insulator 10. For example, as illustrated in part (a) and (b) of FIG. 11, instead of the insulator, a bank portion B formed of a hardly water-soluble resin such as polydimethylsiloxane (PDMS) may be formed on the substrate 2, a film-shaped protective film PM may be provided so as to be supported by the bank portion B, and surfaces of the sensor elements CH1 to CH3 may be covered.

### Eighth Embodiment

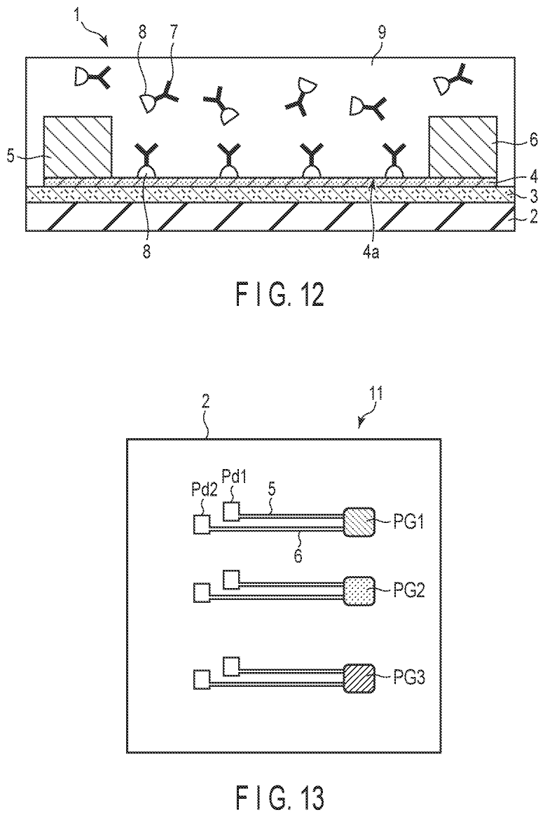

A sealing structure for storing a chemical sensor according to an eighth embodiment will be described with reference to FIG. 12. Here, the same members as those of the first embodiment are denoted by the same reference numerals, and the description thereof will be omitted.

As illustrated in FIG. 12, the sealing structure according to the eighth embodiment is different from the sealing structure described in the first embodiment in that a protective film as the sealing structure further contains probe molecules.

As described in the method of the third embodiment, a protective film 9 can be formed by applying and curing a protective film material on a sensitive film surface 4a, but in a process of forming the sealing structure according to the eighth embodiment, a protective film material containing probe molecules 7 is used. By using such a protective film material, the probe molecules 7 can be bound to the sensitive film surface 4a simultaneously with the formation of the protective film 9. That is, through the process of forming the protective film described above, as illustrated in FIG. 12, there is provided a chemical sensor 11 that includes a sensitive film 4 in which some of probe molecules 7 contained in a protective film material are bound to a surface 4a, and a protective film 9 containing the remaining probe molecules 7.

According to the sealing structure according to the eighth embodiment, a manufacturing process of a sensor including a probe becomes simpler by using the protective film material containing probe molecules, and economic and temporal costs can be reduced.

The chemical sensor 11 in which the sealing structure according to the eighth embodiment is formed can be used in the same manner as that of the fourth embodiment. That is, the sensor can be used by a method including: (S1) preparing a sensor that includes a sensitive film and a protective film disposed so as to cover the sensitive film, and an aqueous solution for removing the protective film; and (S2) dropping the aqueous solution prepared in (S1) on the protective film of the sensor prepared in (S1).

In addition, the chemical sensor on which the sealing structure according to the eighth embodiment is formed may be configured to include a plurality of sensor elements on the same substrate similar to the seventh embodiment. In this case, the compositions of the protective film materials applied to the respective sensor elements are set to be different from each other, such that sensor elements having different uses can be mounted on the same substrate. For example, a protective film material containing different types of probe molecules is prepared and applied to each sensor element, such that it is possible to manufacture a chemical sensor that includes a plurality of sensor elements containing different target substances on the same substrate and sealing each sensor element. For example, three types of protective film materials PG1, PG2, and PG3 may be prepared, and as illustrated in FIG. 13, the sensor elements CH1 to CH3 may be applied separately.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1-9. (canceled)

10. A sealing structure applied to a chemical sensor that includes a sensor element, the sensor element including a substrate, a sensitive film that is provided on the substrate, and a probe molecule for capturing a target substance that is immobilized on a surface of the sensitive film, the sealing structure of the sensor element comprising a protective film that covers the surface of the sensitive film on which the probe molecule is immobilized and is formed of a water-soluble material.

11. A sealing structure applied to a chemical sensor that includes a sensor element, the sensor element including a substrate, a side wall that is erected from the substrate and forms an opening on the substrate, and a sensitive film that has a surface on which a probe molecule for capturing a target substance is immobilized, the surface being exposed to an external environment from the opening, the sealing structure of the sensor element comprising a protective film that seals the opening and is formed of a water-soluble material.

12. The sealing structure according to claim 10, wherein the water-soluble material is a water-soluble resin.

13. The sealing structure according to claim 12, wherein the water-soluble resin is a water-soluble plastic.

14. The sealing structure according to claim 13, wherein the water-soluble plastic is polyvinyl alcohol.

15. The sealing structure according to claim 10, wherein the sensor element includes a source electrode and a drain electrode configured to be electrically connected to the sensitive film, and a gate electrode configured to supply an electric field to the sensitive film.

16. The sealing structure according to claim 15, wherein the source electrode and the drain electrode are covered with an insulator.

17. The sealing structure according to claim 10, wherein the protective film forms a liquid storage structure.

18. A sealing structure applied to a chemical sensor that includes a plurality of sensor elements according to claim 10, the sealing structure of the chemical sensor comprising a plurality of protective films that cover the surface on which the probe molecule of each of the sensor elements is immobilized and are formed of a water-soluble material.

19. A sealing structure applied to a chemical sensor that includes a plurality of sensor elements according to claim 10, the sealing structure of the chemical sensor comprising a protective film that covers the surface on which the probe molecule of each of the sensor elements is immobilized and is formed of a water-soluble material.

20. A sealing structure applied to a chemical sensor that includes a plurality of sensor elements according to claim 11, wherein the side wall and the opening are shared between the plurality of sensor elements, and
the sealing structure of the chemical sensor is composed of a protective film that seals the opening, covers the surface on which the probe molecule of each of the sensor elements is immobilized, and is formed of a water-soluble material.

21. A sealing structure applied to a chemical sensor that includes a plurality of sensor elements that include a substrate and a sensitive film provided on the substrate, the sealing structure of the chemical sensor comprising a plurality of protective films that cover a surface of the sensitive film of each of the sensor elements and are formed of a water-soluble material containing a probe molecule.

22. The sealing structure according to claim 21, wherein types of the probe molecule contained in the water-soluble material are different for each of the protective films.

23. A method of using a chemical sensor that includes the sealing structure according to claim 10, the method comprising:
(S1) preparing an aqueous solution for removing the protective film of the chemical sensor and the chemical sensor; and
(S2) dropping the aqueous solution on the protective film of the prepared chemical sensor.

24. The sealing structure according to claim 11, wherein the water-soluble material is a water-soluble resin.

25. The sealing structure according to claim 24, wherein the water-soluble resin is a water-soluble plastic.

26. The sealing structure according to claim 25, wherein the water-soluble plastic is polyvinyl alcohol.

27. The sealing structure according to claim 11, wherein the sensor element includes a source electrode and a drain electrode configured to be electrically connected to the sensitive film, and a gate electrode configured to supply an electric field to the sensitive film.

28. The sealing structure according to claim 27, wherein the source electrode and the drain electrode are covered with an insulator.

29. A sealing structure applied to a chemical sensor that includes a plurality of sensor elements according to claim 11, the sealing structure of the chemical sensor comprising a plurality of protective films that cover the surface on which the probe molecule of each of the sensor elements is immobilized and are formed of a water-soluble material.

30. A method of using a chemical sensor that includes the sealing structure according to claim 11, the method comprising:
(S1) preparing an aqueous solution for removing the protective film of the chemical sensor and the chemical sensor; and
(S2) dropping the aqueous solution on the protective film of the prepared chemical sensor.
